(19) United States
(12) Patent Application Publication
(10) Pub. No.: US 2025/0267714 A1
(43) Pub. Date: Aug. 21, 2025

(54) RANDOM ACCESS CHANNEL (RACH) PROCEDURE FOR UPLINK-DENSE DEPLOYMENT

(71) Applicant: QUALCOMM Incorporated, San Diego, CA (US)

(72) Inventors: Jae Ho RYU, San Diego, CA (US); Mostafa KHOSHNEVISAN, San Diego, CA (US); Hari SANKAR, San Diego, CA (US)

(21) Appl. No.: 18/583,517

(22) Filed: Feb. 21, 2024

(51) Int. Cl. H04W 74/0833; H04W 74/00

(52) U.S. Cl. CPC H04W 74/0833; H04W 74/002

(57) ABSTRACT

Methods, systems, and devices for wireless communications are described. For example, the described techniques provide for a user equipment (UE) to receive first signaling from a first network entity having uplink and downlink transmission capabilities, the first signaling including an indication of configuration information associated with a second network entity having uplink-only transmission capabilities. The UE may receive second signaling for performing a random access procedure with the second network entity and perform the random access procedure based on the first signaling and a threshold associated with the second signaling. The first signaling may include an indication of a common timing advance group (TAG) or a separate TAG for the first and second network entities. The first signaling may also include an indication of a quantity of beams associated with the second network entity, where the UE transmits one or more random access messages via the quantity of beams.

### FIELD OF TECHNOLOGY

The following relates to wireless communications, including random access channel (RACH) procedure for uplink-dense deployment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may be uplink-dense deployments, including network entities with uplink and downlink transmission capabilities and network entities with uplink-only transmission capabilities.

### SUMMARY

The described techniques relate to improved methods, systems, devices, and apparatuses that support random access channel (RACH) procedure for uplink-dense deployment. For example, the described techniques provide for a user equipment (UE) to receive first signaling from a first network entity having uplink and downlink transmission capabilities. The first signaling may include an indication of configuration information associated with a second network entity having uplink-only transmission capabilities. The UE may receive second signaling for performing a random access procedure with the second network entity and perform the random access procedure with the second network entity based on the configuration information in the first signaling and a threshold associated with the second signaling. In some examples, the first signaling may include an indication of a common timing advance group (TAG) configuration that applies to the first network entity and the second network entity or an indication of a separate TAG configuration for each of the first network entity and the second network entity. Additionally, or alternatively, the first signaling may include an indication of a quantity of beams associated with the second network entity, where the UE transmits one or more random access messages via the quantity of beams.

A method for wireless communications by a UE is described. The method may include receiving first signaling from a first network entity having uplink and downlink transmission capabilities, where the first signaling includes an indication of configuration information associated with a second network entity having uplink-only transmission capabilities, receiving second signaling for performing a random access procedure with the second network entity, and performing the random access procedure with the second network entity based on the configuration information in the first signaling and a threshold associated with the second signaling.

A UE for wireless communications is described. The UE may include one or more memories storing processor executable code, and one or more processors coupled with the one or more memories. The one or more processors may individually or collectively be operable to execute the code to cause the UE to receive first signaling from a first network entity having uplink and downlink transmission capabilities, where the first signaling includes an indication of configuration information associated with a second network entity having uplink-only transmission capabilities, receive second signaling for performing a random access procedure with the second network entity, and perform the random access procedure with the second network entity based on the configuration information in the first signaling and a threshold associated with the second signaling.

Another UE for wireless communications is described. The UE may include means for receiving first signaling from a first network entity having uplink and downlink transmission capabilities, where the first signaling includes an indication of configuration information associated with a second network entity having uplink-only transmission capabilities, means for receiving second signaling for performing a random access procedure with the second network entity, and means for performing the random access procedure with the second network entity based on the configuration information in the first signaling and a threshold associated with the second signaling.

A non-transitory computer-readable medium storing code for wireless communications is described. The code may include instructions executable by one or more processors to receive first signaling from a first network entity having uplink and downlink transmission capabilities, where the first signaling includes an indication of configuration information associated with a second network entity having uplink-only transmission capabilities, receive second signaling for performing a random access procedure with the second network entity, and perform the random access procedure with the second network entity based on the configuration information in the first signaling and a threshold associated with the second signaling.

In some examples of the method, UEs, and non-transitory computer-readable medium described herein, receiving the first signaling may include operations, features, means, or instructions for receiving an indication of a common TAG configuration that applies to both the first network entity and the second network entity, where performing the random access procedure with either the first network entity or the second network entity may be based on the indication of the common TAG configuration.

In some examples of the method, UEs, and non-transitory computer-readable medium described herein, receiving the first signaling may include operations, features, means, or instructions for receiving an indication of a separate TAG configuration for each of the first network entity and the second network entity, where performing the random access procedure with the second network entity may be based on the indication of the separate TAG configuration.

In some examples of the method, UEs, and non-transitory computer-readable medium described herein, receiving the first signaling may include operations, features, means, or instructions for receiving an indication of a first quantity of beams associated with the second network entity and a RACH occasion, where performing the random access procedure with the second network entity may be based on the indication of the first quantity of beams. In some examples of the method, UEs, and non-transitory computer-readable medium described herein, the signaling for performing the random access procedure with the second network entity may be the same or different than signaling for performing a random access procedure with a third network entity having uplink-only transmission capabilities.

In some examples of the method, UEs, and non-transitory computer-readable medium described herein, performing the random access procedure may include operations, features, means, or instructions for transmitting, via one or more random access occasions associated with each of a first quantity of beams of the second network entity, one or more random access messages to the second network entity based on the second network entity having the uplink-only transmission capabilities.

Some examples of the method, UEs, and non-transitory computer-readable medium described herein may further include operations, features, means, or instructions for receiving an indication of the first quantity of beams as a subset of a second quantity of beams and randomly selecting, from a set of random access occasions associated with the second quantity of beams, the one or more random access occasions for transmitting the one or more random access messages via the first quantity of beams.

Some examples of the method, UEs, and non-transitory computer-readable medium described herein may further include operations, features, means, or instructions for receiving an indication of the threshold, where the threshold may be based on a signal strength associated with the first network entity and performing the random access procedure with the second network entity based on the signal strength not exceeding the threshold.

Some examples of the method, UEs, and non-transitory computer-readable medium described herein may further include operations, features, means, or instructions for receiving a random access response (RAR) message based on performing the random access procedure, where the RAR message includes an identifier of either the first network entity or the second network entity based on a random access radio network temporary identifier associated with the RAR message or a field indication in the RAR message. In some examples of the method, UEs, and non-transitory computer-readable medium described herein, the RAR message further includes an indication of a timing advance value to be applied to a TAG associated with the second network entity based on a separate TAG configuration for each of the first network entity and the second network entity. In some examples of the method, UEs, and non-transitory computer-readable medium described herein, the RAR message further includes an indication of a reserved timing advance field or an indication of a timing advance value to be applied to a common TAG based on a common TAG configuration for both the first network entity and the second network entity.

Some examples of the method, UEs, and non-transitory computer-readable medium described herein may further include operations, features, means, or instructions for receiving a physical downlink control channel (PDCCH) order from the first network entity and receiving an indication of a RACH configuration associated with the second network entity, where performing the random access procedure may be based on receiving the indication of the RACH configuration.

Some examples of the method, UEs, and non-transitory computer-readable medium described herein may further include operations, features, means, or instructions for receiving, from the first network entity, a RAR message including a first indication that one or more uplink messages associated with the random access procedure were undetected by the second network entity, where the RAR message further includes a second indication of a transmit power control and retransmitting the one or more uplink messages associated with the random access procedure to the second network entity in accordance with an updated transmission power based on the second indication. In some examples of the method, UEs, and non-transitory computer-readable medium described herein, the first indication may be based on a bit in the RAR message or a value in a frequency domain resource assignment.

A method for wireless communications by a first network entity having uplink and downlink transmission capabilities is described. The method may include outputting first signaling to a UE, where the first signaling includes an indication of configuration information associated with a second network entity having uplink-only transmission capabilities, outputting second signaling for performing a random access procedure with the second network entity, and performing the random access procedure between the second network entity and the UE based on the configuration information in the first signaling and a threshold associated with the second signaling.

A first network entity having uplink and downlink transmission capabilities for wireless communications is described. The first network entity having uplink and downlink transmission capabilities may include one or more memories storing processor executable code, and one or more processors coupled with the one or more memories. The one or more processors may individually or collectively be operable to execute the code to cause the first network entity having uplink and downlink transmission capabilities to output first signaling to a UE, where the first signaling includes an indication of configuration information associated with a second network entity having uplink-only transmission capabilities, output second signaling for performing a random access procedure with the second network entity, and perform the random access procedure between the second network entity and the UE based on the configuration information in the first signaling and a threshold associated with the second signaling.

Another first network entity having uplink and downlink transmission capabilities for wireless communications is described. The first network entity having uplink and downlink transmission capabilities may include means for outputting first signaling to a UE, where the first signaling includes an indication of configuration information associated with a second network entity having uplink-only transmission capabilities, means for outputting second signaling for performing a random access procedure with the second network entity, and means for performing the random access procedure between the second network entity and the UE based on the configuration information in the first signaling and a threshold associated with the second signaling.

A non-transitory computer-readable medium storing code for wireless communications is described. The code may include instructions executable by one or more processors to output first signaling to a UE, where the first signaling includes an indication of configuration information associated with a second network entity having uplink-only transmission capabilities, output second signaling for performing a random access procedure with the second network entity, and perform the random access procedure between the second network entity and the UE based on the configuration information in the first signaling and a threshold associated with the second signaling.

In some examples of the method, first network entity having uplink and downlink transmission capabilities, and non-transitory computer-readable medium described herein, providing, via a backhaul connection with the second network entity, signaling associated with the random access procedure between the UE and the second network entity.

In some examples of the method, first network entity having uplink and downlink transmission capabilities, and non-transitory computer-readable medium described herein, outputting the first signaling may include operations, features, means, or instructions for outputting an indication of a common TAG configuration that applies to both the first network entity and the second network entity, where performing the random access procedure with the UE may be based on the indication of the common TAG configuration.

In some examples of the method, first network entity having uplink and downlink transmission capabilities, and non-transitory computer-readable medium described herein, outputting the first signaling may include operations, features, means, or instructions for outputting an indication of a separate TAG configuration for each of the first network entity and the second network entity, where performing the random access procedure with the UE may be based on the indication of the separate TAG configuration.

In some examples of the method, first network entity having uplink and downlink transmission capabilities, and non-transitory computer-readable medium described herein, outputting the first signaling may include operations, features, means, or instructions for outputting an indication of a first quantity of beams associated with the second network entity and a RACH occasion, where performing the random access procedure may be based on the indication of the first quantity of beams.

In some examples of the method, first network entity having uplink and downlink transmission capabilities, and non-transitory computer-readable medium described herein, the signaling for performing the random access procedure with the second network entity may be the same or different than signaling for performing a random access procedure with a third network entity having uplink-only transmission capabilities.

Some examples of the method, first network entity having uplink and downlink transmission capabilities, and non-transitory computer-readable medium described herein may further include operations, features, means, or instructions for outputting an indication of a first quantity of beams as a subset of a second quantity of beams, the first quantity of beams associated with one or more random access messages, where the random access procedure may be based on the indication.

Some examples of the method, first network entity having uplink and downlink transmission capabilities, and non-transitory computer-readable medium described herein may further include operations, features, means, or instructions for outputting an indication of the threshold, where the threshold may be based on a signal strength associated with the first network entity and performing the random access procedure between the second network entity and the UE based on the signal strength not exceeding the threshold.

Some examples of the method, first network entity having uplink and downlink transmission capabilities, and non-transitory computer-readable medium described herein may further include operations, features, means, or instructions for outputting a RAR message based on performing the random access procedure, where the RAR message includes an identifier of either the first network entity or the second network entity based on a random access radio network temporary identifier associated with the RAR or a field indication in the RAR message.

In some examples of the method, first network entity having uplink and downlink transmission capabilities, and non-transitory computer-readable medium described herein, the RAR message further includes an indication of a timing advance value to be applied to a TAG associated with the second network entity based on a separate TAG configuration for each of the first network entity and the second network entity. In some examples of the method, first network entity having uplink and downlink transmission capabilities, and non-transitory computer-readable medium described herein, the RAR message further includes an indication of a reserved timing advance field or an indication of a timing advance value to be applied to a common TAG based on a common TAG configuration for both the first network entity and the second network entity.

Some examples of the method, first network entity having uplink and downlink transmission capabilities, and non-transitory computer-readable medium described herein may further include operations, features, means, or instructions for outputting a PDCCH order to the UE and outputting an indication of a RACH configuration associated with the second network entity, where performing the random access procedure between the second network entity and the UE may be based on outputting the indication of the RACH configuration.

Some examples of the method, first network entity having uplink and downlink transmission capabilities, and non-transitory computer-readable medium described herein may further include operations, features, means, or instructions for outputting, to the UE, a RAR message including a first indication that one or more uplink messages associated with the random access procedure were undetected by the second network entity, where the RAR message further includes a second indication of a transmit power control. In some examples of the method, first network entity having uplink and downlink transmission capabilities, and non-transitory computer-readable medium described herein, the first indication may be based on a bit in the RAR message or a value in a frequency domain resource assignment.

### BRIEF DESCRIPTION OF THE DRAWINGS

FIGS. 1 and 2 show examples of wireless communications systems that support a random access channel (RACH) procedure for uplink-dense deployment in accordance with one or more aspects of the present disclosure.

FIG. 3 shows an example of a process flow that supports a RACH procedure for uplink-dense deployment in accordance with one or more aspects of the present disclosure.

FIGS. 4 and 5 show block diagrams of devices that support a RACH procedure for uplink-dense deployment in accordance with one or more aspects of the present disclosure.

FIG. 6 shows a block diagram of a communications manager that supports a RACH procedure for uplink-dense deployment in accordance with one or more aspects of the present disclosure.

FIG. 7 shows a diagram of a system including a device that supports a RACH procedure for uplink-dense deployment in accordance with one or more aspects of the present disclosure.

FIGS. 8 and 9 show block diagrams of devices that support a RACH procedure for uplink-dense deployment in accordance with one or more aspects of the present disclosure.

FIG. 10 shows a block diagram of a communications manager that supports a RACH procedure for uplink-dense deployment in accordance with one or more aspects of the present disclosure.

FIG. 11 shows a diagram of a system including a device that supports a RACH procedure for uplink-dense deployment in accordance with one or more aspects of the present disclosure.

FIGS. 12 through 14 show flowcharts illustrating methods that support a RACH procedure for uplink-dense deployment in accordance with one or more aspects of the present disclosure.

### DETAILED DESCRIPTION

Some wireless communications systems may include uplink-dense deployments to improve coverage and capacity for uplink communications. For example, an uplink-dense deployment may include a transmission reception point (TRP) with uplink (UL) and downlink (DL) capabilities as well as one or more UL-only TRPs connected to the UL/DL-TRP via a backhaul connection. In an uplink-dense deployment, UL signals from a user equipment (UE) may be received by the UL-only TRP, and DL signals may be transmitted from the UL/DL-TRP, which may be a serving cell for the UE. However, it may not be desirable for a UE to connect to an UL-only TRP when it is more advantageous to connect to the UL/DL-TRP. For example, the UL/DL-TRP may be associated with a higher signal strength than an UL-only TRP. In some examples, the UE may connect to an UL-only TRP and initialize transmit power and timing advance (TA) via a RACH procedure, but a RACH procedure for UL-only TRP is not currently defined.

The techniques described herein provide support for a UE to avoid connection to UL-only TRP when it is more advantageous to connect to the DL/UL-TRP, as well as a RACH procedure toward UL-only TRP in an uplink-dense deployment. For example, a network entity (e.g., UL/DL TRP) may configure a threshold (e.g., RSRP threshold) for PRACH transmission for UL-only network entity (e.g., a UL-only TRP). A UE may measure a signal strength of one or more reference signals and connect to the network entity based on the signal strength exceeding the threshold. In some cases, the signal strength may be lower than the threshold and the UE may connect to the UL-only network entity via a RACH procedure. In such cases, the network entity may transmit configuration signaling to the UE that includes an indication of a common timing advance group (TAG) or a separate TAG for the UL-only network entity. Additionally, or alternatively, the network entity may configure a quantity of beams for the RACH procedure with the UL-only network entity, which may be shared among multiple UL-only network entities or separate for different UL-only network entities.

The UE may transmit RACH preambles in multiple resource occasions (ROs) associated with each of the quantity of beams of the UL-only network entity. In some cases, the network entity may configure a quantity of beams less than the total quantity of beams available for the RACH procedure (e.g., to mitigate collision among UEs). In some examples, the UE may receive a random access response (RAR) from a serving cell, and the UE may differentiate the RAR for the network entity and the UL-only network entity based on a random access radio network temporary identifier (RA-RNTI) or based on an explicit field in the RAR. In some cases, the network entity may indicate which RACH configuration to use between the network entity and the UL-only network entity based on a field in physical downlink control channel (PDCCH) order downlink control information (DCI). In some examples, the network entity may transmit the RAR with an indication that the RACH preambles were detected by the network entity but not by the UL-only network entity. In such cases, the UE may retransmit the RACH preambles with an updated transmit power according to a transmit power control command in the UL grant in the RAR.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to RACH procedure for uplink-dense deployment.

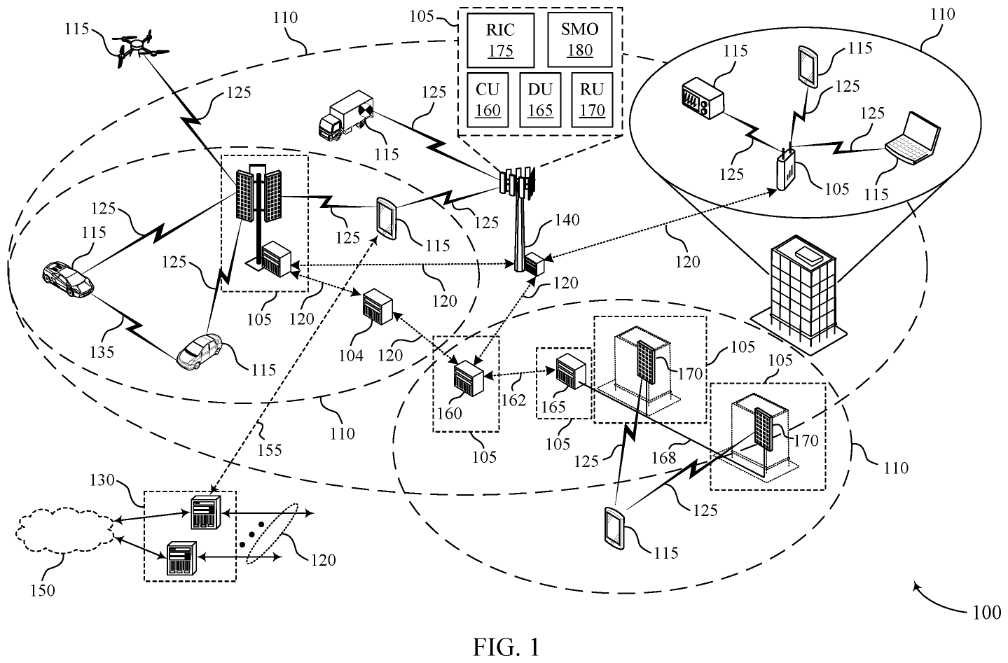

FIG. 1 shows an example of a wireless communications system 100 that supports RACH procedure for uplink-dense deployment in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Some wireless communications systems 100 may include uplink-dense deployments to improve coverage and capacity for uplink communications. For example, an uplink-dense deployment may include a TRP with UL and DL capabilities as well as one or more UL-only TRPs connected to the UL/DL-TRP via a backhaul communication link 120. In an uplink-dense deployment, UL signals from a UE 115 may be received by the UL-only TRP, and DL signals may be transmitted from the UL/DL-TRP, which may be a serving cell for the UE 115. However, it may not be desirable for a UE 115 to connect to an UL-only TRP when it is more advantageous to connect to the UL/DL-TRP. For example, the UL/DL-TRP may be associated with a higher signal strength than an UL-only TRP. In some examples, the UE 115 may connect to an UL-only TRP and initialize transmit power and TA via a RACH procedure, but a RACH procedure for UL-only TRP is not currently defined.

The techniques described herein provide support for a UE 115 to avoid connection to UL-only TRP when it is more advantageous to connect to the DL/UL-TRP, as well as a RACH procedure toward UL-only TRP in an uplink-dense deployment. For example, a network entity 105 (e.g., UL/DL TRP) may configure a threshold (e.g., RSRP threshold) for PRACH transmission for an UL-only network entity 105 (e.g., a UL-only TRP). A UE 115 may measure a signal strength of one or more reference signals and connect to the network entity 105 based on the signal strength exceeding the threshold. In some cases, the signal strength may be lower than the threshold and the UE 115 may connect to the UL-only network entity 105 via a RACH procedure. In such cases, the network entity 105 may transmit configuration signaling to the UE 115 that includes an indication of a common TAG or a separate TAG for the UL-only network entity 105. Additionally, or alternatively, the network entity 105 may configure a quantity of beams for the RACH procedure with the UL-only network entity 105, which may be shared among multiple UL-only network entities 105 or separate for different UL-only network entities 105.

The UE 115 may transmit one or more RACH preambles in multiple ROs associated with each of the quantity of beams of the UL-only network entity 105. In some cases, the network entity 105 may configure a quantity of beams less than the total quantity of beams available for the RACH procedure (e.g., to mitigate collision among UEs 115). In some examples, the UE 115 may receive a RAR from a serving cell, and the UE 115 may differentiate the RAR for the network entity 105 and the UL-only network entity 105 based on a separate RA-RNTI or based on an explicit field in the RAR. In some cases, the network entity 105 may indicate which RACH configuration to use between the network entity 105 and the UL-only network entity 105 based on a field in PDCCH order DCI. In some examples, the network entity 105 may transmit the RAR with an indication that the RACH preambles were detected by the network entity 105 but not by the UL-only network entity 105. In such cases, the UE 115 may retransmit the RACH preambles with an updated transmit power according to a transmit power control command in the UL grant in the RAR.

In some wireless communications systems 100, a network entity 105 may apply DL and UL beam sweep during initial access with a UE 115. For example, within a signal synchronization block (SSB) burst, the network entity 105 may transmit multiple SSBs with DL beam sweep. A UE 115 may determine which SSBs within the SSB burst are transmitted by the network entity 105 via parameter (e.g., ssb-PositionsInBurst). In some examples, the network entity 105 may apply an UL beam sweep for PRACH reception. The network entity 105 may configure one or multiple RACH occasions per transmitted SSB. Additionally, or alternatively, the network entity 105 may configure one RACH occasion for a group of transmitted SSBs.

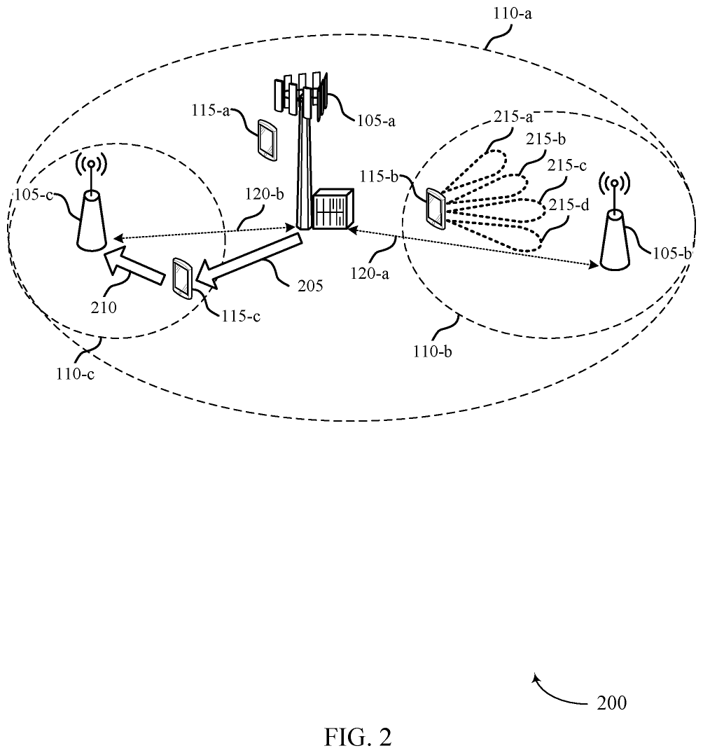

FIG. 2 shows an example of a wireless communications system 200 that supports RACH procedure for uplink-dense deployment in accordance with one or more aspects of the present disclosure. FIG. 2 illustrates a wireless communications system 200 including a network entity 105-a capable of uplink and downlink communications (e.g., an UL/DL TRP), a first UL-only network entity 105-b, and a second UL-only network entity 105-c. The wireless communications system 200 may be an uplink-dense deployment. In some examples, an uplink-dense deployment may improve a coverage, capacity, or both, of uplink communications. In some cases, an uplink-dense deployment may be considered an asymmetric DL/UL densification.

In some examples, the network entity 105-a may transmit one or more downlink signals 205 to a UE 115 in an UL/DL serving cell corresponding to coverage area 110-a. In some examples, one or more uplink signals 210 of a UE 115 (e.g., a UE 115-b or a UE 115-c) may be received by an UL-only network entity (e.g., the UL-only network entity 105-b or the UL-only network entity 105-c). The UL-only network entity 105-b and the network entity 105-c may be connected to the network entity 105-a via a backhaul communication link 120-a and a backhaul communication link 120-b, respectively. In some cases, the UL-only network entity 105-b and the UL-only network entity 105-c may not transmit any downlink signal (e.g., the UL-only network entities may receive an uplink signal and send it to a macro node with or without processing).

Signal strength may be related to a proximity of a UE 115 to a network entity 105, and in some examples, it may not be advantageous for a UE 115 to connect to an UL-only network entity when the UE 115 is closer to an UL/DL network entity than the UL-only network entity. For example, the UE 115-a is closer to the network entity 105-a than either the UL-only network entity 105-b or the network entity 105-c. In some cases, the UE 115-a may transmit one or more uplink signals to either the UL-only network entity 105-b or the UL-only network entity 105-c with a higher power compared to transmitting the one or more uplink signals to the network entity 105-a. Additionally, or alternatively, (e.g., in a FR1 deployment) the one or more transmissions from the UE 115-a toward the far (e.g., compared to the network entity 105-a) UL-only network entity 105-b or UL-only network entity 105-c may introduce higher interference in an uplink reception of the network entity 105-a. In some cases, a UE 115 may initialize transmit power and TA based on a RACH procedure. However, other wireless communications systems may not support a RACH procedure for UL-only network entities.

The wireless communications system 200 supports techniques for a UE 115 to avoid connection to an UL-only network entity (e.g., the UL-only network entity 105-b or the UL-only network entity 105-c) when it is more advantageous to connect to a network entity with uplink and downlink capabilities (e.g., the network entity 105-a). The wireless communications system 200 also supports techniques for a RACH procedure toward UL-only network entities (e.g., the UL-only network entity 105-b or the UL-only network entity 105-c).

In some examples, the network entity 105-a may transmit configuration signaling to a UE 115 (e.g., the UE 115-b or the UE 115-c). For example, the network entity 105-a may configure a threshold for PRACH transmission toward an UL-only network entity, such as the UL-only network entity 105-b, the UL-only network entity 105-c, or both. In some cases, the threshold may be an RSRP threshold. In such cases, a UE 115 may measure an RSRP (e.g., SSB RSRP, CSI RSRP, among other examples) received from the network entity 105-a. The UE 115 may transmit PRACH toward an UL-only network entity based on the measured RSRP being less than the threshold (e.g., to prevent the UE 115 from connecting to UL-only TRP when the UE 115 is close to UL/DL-TRP). For example, the UE 115-a may connect to the network entity 105-a based on measuring RSRP that exceeds the threshold, and UE 115-b may connect to the UL-only network entity 105-b based on measuring RSRP that is less than the threshold. In some cases, the threshold may be a radius distance from the network entity 105-a. For example, a UE 115 may transmit PRACH toward an UL-only network entity based on a distance from the network entity 105-a exceeding the threshold radius distance.

Additionally, or alternatively, the configuration signaling may include an indication for a TAG configuration. For example, the configuration signaling may include common TAG or separate TAG for the UL-only network entity 105-b, the UL-only network entity 105-c, or both. For example, the network entity 105-a may configure common TAG when a propagation delay between the network entity 105-a and the UL-only network entity 105-b and the UL-only network entity 105-c is negligible. For a common TAG configuration, the network entity 105-a may configure a RACH procedure toward the UL-only network entity 105-b to help the UE 115-b identify the UL-only network entity 105-b and determine an initial transmit power. Additionally, or alternatively, the UE 115-b may use TA for the network entity 105-a for PRACH transmission for the UL-only network entity 105-b. In other examples, the network entity 105-a may transmit configuration signaling for a separate TAG configuration. In such examples, the network entity 105-a may configure a RACH procedure toward the UL-only network entity 105-b to help the UE 115-b identify the UL-only network entity 105-b and determine a transmit timing and initial transmit power. In some cases, the UE 115-b may use downlink reference signals from the network entity 105-a to derive a downlink reference timing for uplink transmission irrespective of whether common TAG or separate TAG is configured.

In some examples, the network entity 105-a may transmit configuration signaling for a quantity of receive beams for PRACH with an UL-only network entity. For example, the network entity 105-a may transmit a parameter that includes an indication of a quantity of transmitted beams (e.g., SSBs). In some examples, the RACH configuration may be shared among multiple UL-only network entities (e.g., shared among the UL-only network entity 105-b and the UL-only network entity 105-c). In some examples, the RACH configuration may be separate for different UL-only network entities (e.g., separate for the UL-only network entity 105-b and the UL-only network entity 105-c).

A UE 115 may not determine which receive beam of an UL-only network entity is more advantageous for RACH reception because the UL-only network entity may not transmit downlink reference signals. A UE 115 may transmit one or more random access preambles 215 in multiple ROs associated with each receive beam of an UL-only network entity. For example, the UE 115-b may transmit a random access preamble 215-a, a random access preamble 215-b, a random access preamble 215-c, and a random access preamble 215-d to the UL-only network entity 105-b via one or more ROs. In some examples, the network entity 105-a may transmit configuration signaling to the UE 115-b that indicates a quantity M less than a quantity of receive beams for PRACH (e.g., M out of a total quantity of available receive beams). In some cases, the indication of M may enable the network entity 105-a to control a density of PRACH transmission toward UL-only network entities. For example, when M is configured, the UE 115-b may randomly select M ROs out of the quantity of receive beams for PRACH ROs for each RACH attempt (e.g., to mitigate collision among UEs 115). In some examples, the UE 115-b transmits the one or more random access preambles 215 in one RO associated with one selected SSB (e.g., for the network entity 105-a). In some cases, the UE 115-b may randomly select one RO among multiple ROs when the multiple ROs are associated with one receive beam.

The UEs 115 (e.g., UE 115-a, UE 115-b, or UE 115-c) may receive an RAR message from a serving cell (e.g., the network entity 105-a and corresponding coverage area 110-a). In some examples, the serving cell may be a serving cell associated with an UL-only network entity (e.g., corresponding to the coverage area 110-b or coverage area 110-c within the coverage area 110-a) or a different serving cell. The UEs 115 may differentiate the RAR message for the network entity 105-a and an UL-only network entity (e.g., UL-only network entity 105-b or UL-only network entity 105-c) based on a separate RA-RNTI to monitor PDCCH scheduling RAR physical downlink shared channel (PDSCH). Additionally, or alternatively, the UEs 115 may differentiate the RAR message based on an explicit field in the RAR message. For example, a bit field in the RAR message may indicate whether the RAR message is associated with the network entity 105-a or the UL-only network entity 105-b. The RAR message may indicate the TA based on a separate TAG configuration for an UL-only network entity. Additionally, or alternatively, the TA field in the RAR message may be reserved based on a common TA configuration for an UL-only network entity.

In some examples, the RACH procedure is based on a PDCCH order. For example, the network entity 105-a may indicate which RACH configuration to use between the network entity 105-a and the UL-only network entity 105-b. In some cases, the indication is based on a field in the PDCCH order DCI. In some cases, the network entity 105-a may detect a PRACH transmission from the UE 115-b, but the UL-only network entity 105-b may not detect the PRACH transmission (e.g., due to wrong transmission power at the UE 115-b). For example, the received power of PRACH may be too low or too high at the UL-only network entity 105-b, which may prevent successful PRACH detection at the UL-only network entity 105-b. In such cases, the network entity 105-a may transmit a RAR message with an indication that PRACH was detected by the network entity 105-a but not by the UL-only network entity 105-b. In some examples, the network entity 105-a may transmit the indication using a bit field (e.g., reserved bit field or new bit field) in the RAR message. Additionally, or alternatively, the network entity 105-a may transmit the indication using an invalid value in a frequency domain resource assignment (FDRA) of an uplink grant in the RAR message. The UE 115-b may receive the RAR with the indication and retransmit the PRACH with an updated transmit power according to a transmit power control (TPC) command in the uplink grant in the RAR message.

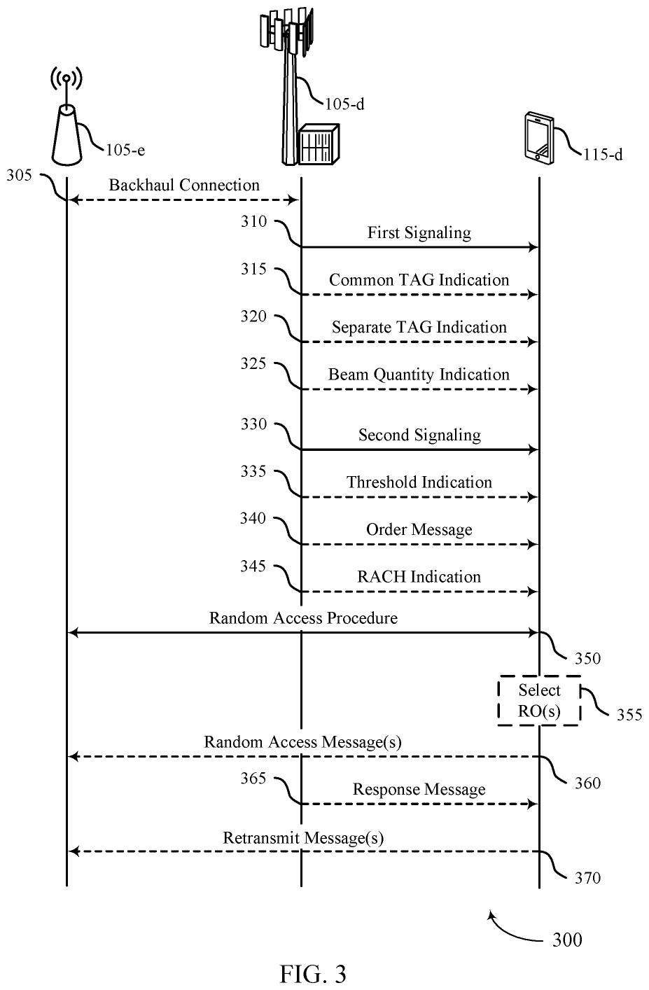

FIG. 3 shows an example of a process flow 300 that supports RACH procedure for uplink-dense deployment in accordance with one or more aspects of the present disclosure. The process flow 300 may be implemented by aspects of the wireless communications system 100 and 200. For example, an UL-only network entity 105-e, a network entity 105-d, and a UE 115-d, which may be examples of a UE 115 or network entity 105 as described herein, may perform aspects of the process flow 300. In the following description of the process flow 300, operations performed by the UL-only network entity 105-e, the network entity 105-d, and the UE 115-d may be performed in a different order than is shown. Some operations may be omitted from the process flow 300, and other operations may be added to the process flow 300. Further, although some operations or signaling may be shown to occur at different times for discussion purposes, these operations may occur at the same time.

At 305, the network entity 105-d may provide a backhaul connection to the UL-only network entity 105-e. For example, the network entity 105-d may have uplink and downlink transmission capabilities and the UL-only network entity 105-e may have uplink-only transmission capabilities. The network entity 105-d may communicate with the UL-only network entity 105-e via the backhaul connection (e.g., to relay wireless communications received at the UL-only network entity 105-e and transmit a response via the network entity 105-d).

At 310, the UE 115-d may receive first signaling from the network entity 105-d. In some examples, at 315, the UE 115-d may receive an indication of a common TAG configuration that applies to both the network entity 105-d and the UL-only network entity 105-e as part of the first signaling, as described in further detail with reference to FIG. 2. For example, the UE 115-d may apply a TA value to the common TA. Additionally, or alternatively, at 320, the UE 115-d may receive an indication of a separate TAG configuration for each of the network entity 105-d and the UL-only network entity 105-e. For example, the TA value in a RAR message may be applied to TAG associated with the UL-only network entity 105-e.

At 325 the UE 115-d may receive an indication of a first quantity of beams associated with the UL-only network entity 105-e and a RACH occasion. In some cases, the UE 115-d may receive the indication of the first quantity of beams as a subset of a second quantity of beams. For example, the network entity 105-d may transmit an indication of M beams out of a quantity of beams to control a density of PRACH transmission toward the UL-only network entity 105-e.

At 330, the UE 115-d may receive second signaling for performing a random access procedure with the UL-only network entity 105-e. In some examples, the signaling for performing the random access procedure with the UL-only network entity 105-e may be the same or different than signaling for performing a random access procedure with another UL-only network entity 105. For example, the network entity 105-d may transmit configuration signaling for a RACH configuration that is shared among multiple UL-only network entities or the network entity 105-d may transmit configuration signaling for a RACH configuration that is separate for different UL-only network entities.

At 335, the UE 115-d may receive an indication of a threshold as part of the second signaling, as discussed further with reference to FIG. 2. The threshold may be based on a signal strength associated with the network entity 105-d, a radius distance from the network entity 105-d, or both. In some examples, the UE 115-d may perform a random access procedure with the UL-only network entity 105-e based on the signal strength not exceeding the threshold. In other examples, the UE 115-d may perform a random access procedure with the network entity 105-d based on the signal strength exceeding the threshold. In some examples, at 340, the UE 115-d may receive a PDDCH order from the network entity 105-d. At 345, the UE 115-d may receive an indication of a RACH configuration associated with the UL-only network entity 105-e.

At 350, the UE 115-d performs a random access procedure with the UL-only network entity 105-e based on the configuration information in the first signaling and the threshold associated with the second signaling. For example, the UE 115-d may perform the random access procedure based on the indication of the common TAG configuration or the indication of the separate TAG configuration. Additionally, or alternatively, the UE 115-d may perform the random access procedure based on the indication of the first quantity of beams. For example, the UE 115-d may transmit PRACH in multiple ROs associated with each receive beam of the UL-only network entity 105-e. In some examples, the UE 115-d may perform the random access procedure based on receiving the indication of the RACH configuration. The network entity 105-d may perform the random access procedure between the UL-only network entity 105-e and the UE 115-d based on the configuration information in the first signaling and the threshold. For example, the network entity 105-d may provide, via the backhaul connection with the UL-only network entity 105-e, signaling associated with the random access procedure between the UE 115-d and the UL-only network entity 105-e.

At 355, the UE 115-d may randomly select, from a set of random access occasions associated with the second quantity of beams, one or more random access occasions for transmitting one or more random access messages via the first quantity of beams. For example, at 360, the UE 115-d may transmit, via the one or more random access occasions associated with each of the first quantity of beams of the UL-only network entity 105-e, the one or more random access messages to the UL-only network entity 105-e based on the UL-only network entity 105-e having the uplink-only transmission capabilities.

At 365, the UE 115-d may receive a random access response message based on performing the random access procedure. The random access response message may include an identifier of either the network entity 105-d or the UL-only network entity 105-e based on a RA-RNTI associated with the random access response message or a field indication in the random access response message. In some examples, the random access response message further includes an indication of a TA value to be applied to a TAG associated with the UL-only network entity 105-e based on a separate TAG configuration for each of the network entity 105-d and the UL-only network entity 105-e. Additionally, or alternatively, the random access response message may include an indication of a reserved TA field or an indication of a TA value to be applied to a common TAG based on a common TAG configuration for both the network entity 105-d and the UL-only network entity 105-e.

In some examples, the UE 115-d may receive, from the network entity 105-d, a RAR including a first indication that one or more uplink messages associated with the random access procedure were undetected by the UL-only network entity 105-e. In some examples, the first indication is based on a bit in the RAR message or a value in a FDRA. The RAR message may further include a second indication of a TPC. At 370, the UE 115-d may retransmit the one or more uplink messages associated with the random access procedure to the UL-only network entity 105-e in accordance with an updated transmission power based on the second indication.

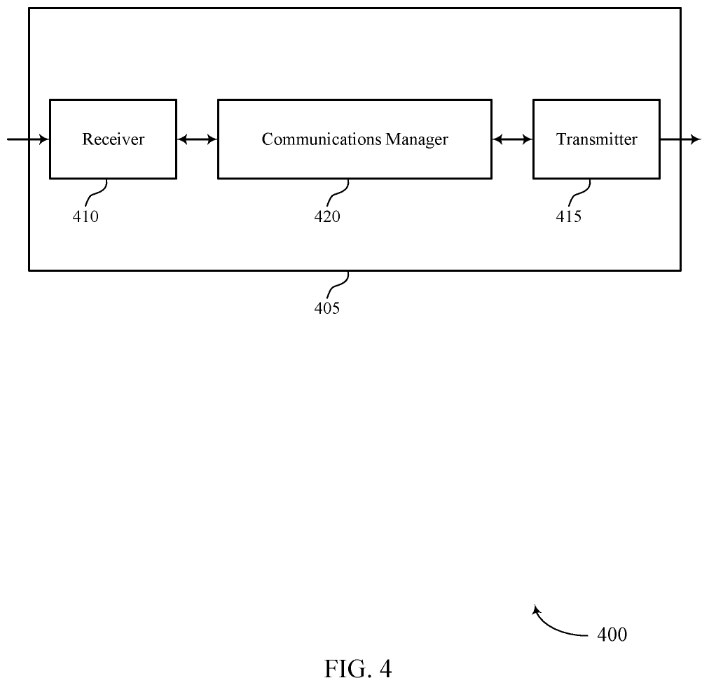

FIG. 4 shows a block diagram 400 of a device 405 that supports RACH procedure for uplink-dense deployment in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to RACH procedure for uplink-dense deployment). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to RACH procedure for uplink-dense deployment). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of RACH procedure for uplink-dense deployment as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving first signaling from a first network entity having uplink and downlink transmission capabilities, where the first signaling includes an indication of configuration information associated with a second network entity having uplink-only transmission capabilities. The communications manager 420 is capable of, configured to, or operable to support a means for receiving second signaling for performing a random access procedure with the second network entity. The communications manager 420 is capable of, configured to, or operable to support a means for performing the random access procedure with the second network entity based on the configuration information in the first signaling and a threshold associated with the second signaling.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, more efficient utilization of communication resources, and the like.

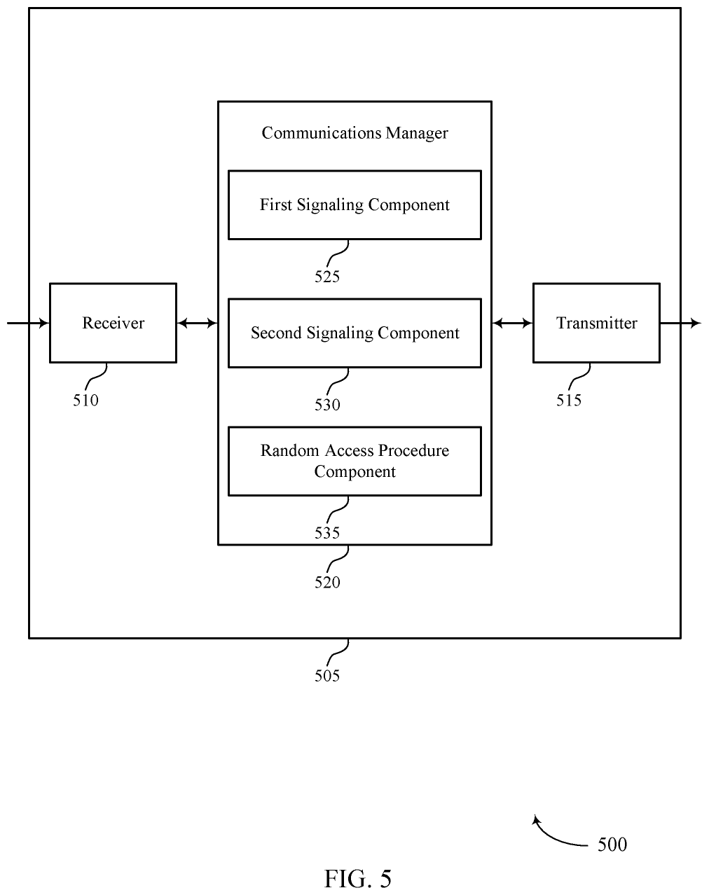

FIG. 5 shows a block diagram 500 of a device 505 that supports RACH procedure for uplink-dense deployment in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to RACH procedure for uplink-dense deployment). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to RACH procedure for uplink-dense deployment). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of RACH procedure for uplink-dense deployment as described herein. For example, the communications manager 520 may include a first signaling component 525, a second signaling component 530, a random access procedure component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The first signaling component 525 is capable of, configured to, or operable to support a means for receiving first signaling from a first network entity having uplink and downlink transmission capabilities, where the first signaling includes an indication of configuration information associated with a second network entity having uplink-only transmission capabilities. The second signaling component 530 is capable of, configured to, or operable to support a means for receiving second signaling for performing a random access procedure with the second network entity. The random access procedure component 535 is capable of, configured to, or operable to support a means for performing the random access procedure with the second network entity based on the configuration information in the first signaling and a threshold associated with the second signaling.

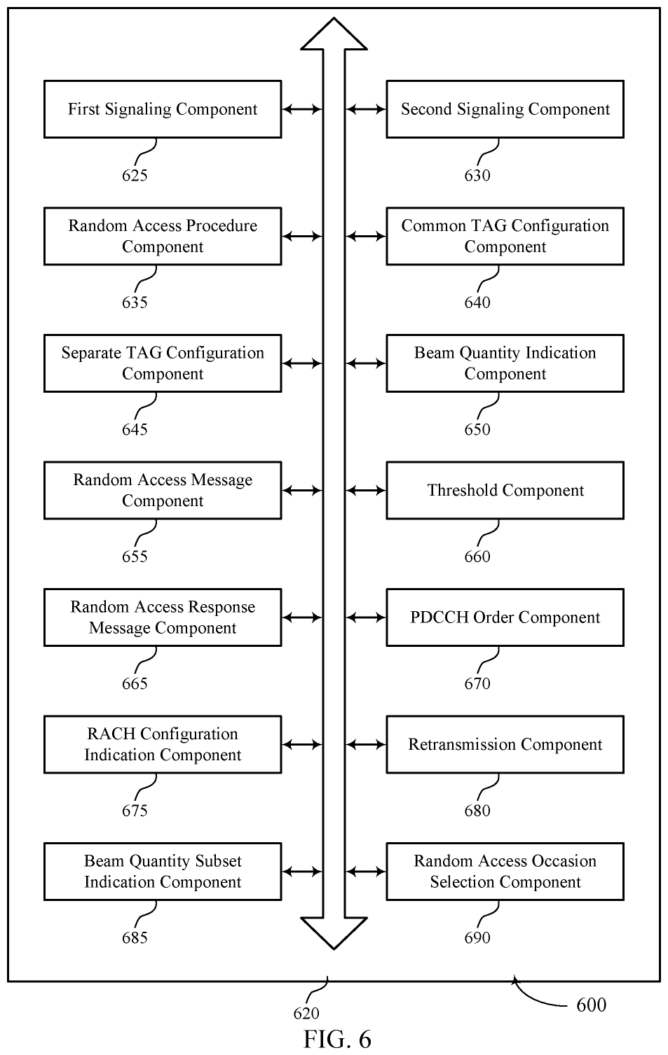

FIG. 6 shows a block diagram 600 of a communications manager 620 that supports RACH procedure for uplink-dense deployment in accordance with one or more aspects of the present disclosure. The communications manager 620 may be an example of aspects of a communications manager 420, a communications manager 520, or both, as described herein. The communications manager 620, or various components thereof, may be an example of means for performing various aspects of RACH procedure for uplink-dense deployment as described herein. For example, the communications manager 620 may include a first signaling component 625, a second signaling component 630, a random access procedure component 635, a common TAG configuration component 640, a separate TAG configuration component 645, a beam quantity indication component 650, a random access message component 655, a threshold component 660, a random access response message component 665, a PDCCH order component 670, a RACH configuration indication component 675, a retransmission component 680, a beam quantity subset indication component 685, a random access occasion selection component 690, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The first signaling component 625 is capable of, configured to, or operable to support a means for receiving first signaling from a first network entity having uplink and downlink transmission capabilities, where the first signaling includes an indication of configuration information associated with a second network entity having uplink-only transmission capabilities. The second signaling component 630 is capable of, configured to, or operable to support a means for receiving second signaling for performing a random access procedure with the second network entity. The random access procedure component 635 is capable of, configured to, or operable to support a means for performing the random access procedure with the second network entity based on the configuration information in the first signaling and a threshold associated with the second signaling.

In some examples, to support receiving the first signaling, the common TAG configuration component 640 is capable of, configured to, or operable to support a means for receiving an indication of a common timing advance group configuration that applies to both the first network entity and the second network entity, where performing the random access procedure with either the first network entity or the second network entity is based on the indication of the common timing advance group configuration.

In some examples, to support receiving the first signaling, the separate TAG configuration component 645 is capable of, configured to, or operable to support a means for receiving an indication of a separate timing advance group configuration for each of the first network entity and the second network entity, where performing the random access procedure with the second network entity is based on the indication of the separate timing advance group configuration.

In some examples, to support receiving the first signaling, the beam quantity indication component 650 is capable of, configured to, or operable to support a means for receiving an indication of a first quantity of beams associated with the second network entity and a random access channel occasion, where performing the random access procedure with the second network entity is based on the indication of the first quantity of beams.

In some examples, the signaling for performing the random access procedure with the second network entity is the same or different than signaling for performing a random access procedure with a third network entity having uplink-only transmission capabilities.

In some examples, to support performing the random access procedure, the random access message component 655 is capable of, configured to, or operable to support a means for transmitting, via one or more random access occasions associated with each of a first quantity of beams of the second network entity, one or more random access messages to the second network entity based on the second network entity having the uplink-only transmission capabilities.

In some examples, the beam quantity subset indication component 685 is capable of, configured to, or operable to support a means for receiving an indication of the first quantity of beams as a subset of a second quantity of beams. In some examples, the random access occasion selection component 690 is capable of, configured to, or operable to support a means for randomly selecting, from a set of random access occasions associated with the second quantity of beams, the one or more random access occasions for transmitting the one or more random access messages via the first quantity of beams.

In some examples, receiving an indication of the threshold, where the threshold is based on a signal strength associated with the first network entity. In some examples, performing the random access procedure with the second network entity is based on the signal strength not exceeding the threshold.

In some examples, the random access response message component 665 is capable of, configured to, or operable to support a means for receiving a random access response message based on performing the random access procedure, where the random access response message includes an identifier of either the first network entity or the second network entity based on a random access radio network temporary identifier associated with the random access response message or a field indication in the random access response message.

In some examples, the random access response message further includes an indication of a timing advance value to be applied to a timing advance group associated with the second network entity based on a separate timing advance group configuration for each of the first network entity and the second network entity.

In some examples, the random access response message further includes an indication of a reserved timing advance field or an indication of a timing advance value to be applied to a common timing advance group based on a common timing advance group configuration for both the first network entity and the second network entity.

In some examples, the PDCCH order component 670 is capable of, configured to, or operable to support a means for receiving a physical downlink control channel order from the first network entity. In some examples, the RACH configuration indication component 675 is capable of, configured to, or operable to support a means for receiving an indication of a random access channel configuration associated with the second network entity, wherein performing the random access procedure is based on receiving the indication of the random access channel configuration.

In some examples, the random access response message component 665 is capable of, configured to, or operable to support a means for receiving, from the first network entity, a random access response message including a first indication that one or more uplink messages associated with the random access procedure were undetected by the second network entity, where the random access response message further includes a second indication of a transmit power control. In some examples, the retransmission component 680 is capable of, configured to, or operable to support a means for retransmitting the one or more uplink messages associated with the random access procedure to the second network entity in accordance with an updated transmission power based on the second indication. In some examples, the first indication is based on a bit in the random access response message or a value in a frequency domain resource assignment.

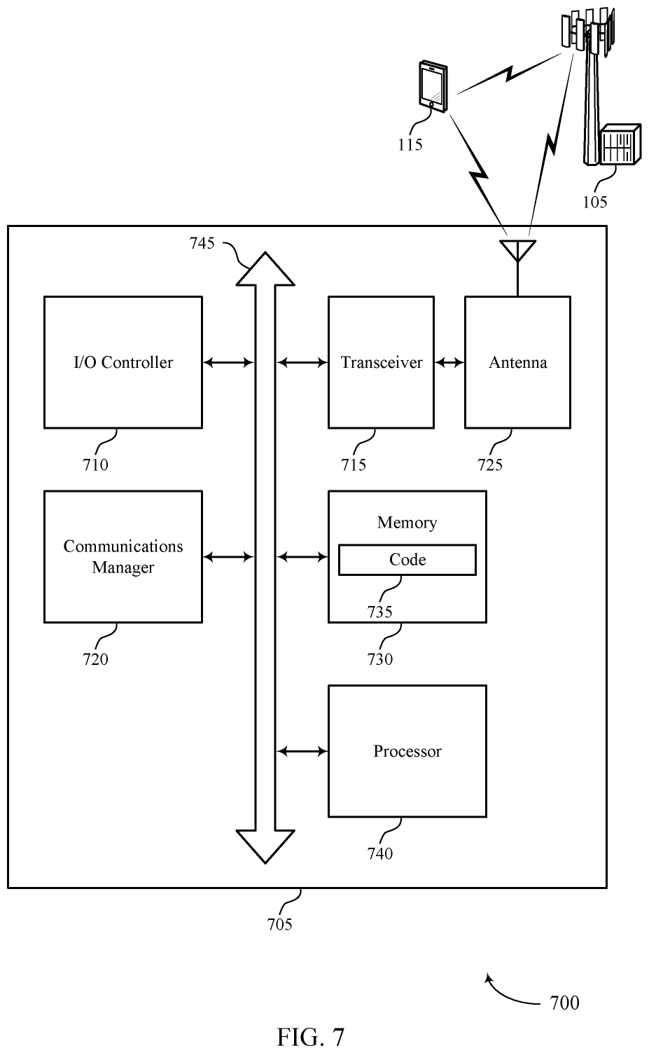

FIG. 7 shows a diagram of a system 700 including a device 705 that supports RACH procedure for uplink-dense deployment in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting RACH procedure for uplink-dense deployment). For example, the device 705 or a component of the device 705 may include at least one processor 740 and at least one memory 730 coupled with or to the at least one processor 740, the at least one processor 740 and the at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving first signaling from a first network entity having uplink and downlink transmission capabilities, where the first signaling includes an indication of configuration information associated with a second network entity having uplink-only transmission capabilities. The communications manager 720 is capable of, configured to, or operable to support a means for receiving second signaling for performing a random access procedure with the second network entity. The communications manager 720 is capable of, configured to, or operable to support a means for performing the random access procedure with the second network entity based on the configuration information in the first signaling and a threshold associated with the second signaling.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, and improved utilization of processing capability, among other examples.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of RACH procedure for uplink-dense deployment as described herein, or the at least one processor 740 and the at least one memory 730 may be otherwise configured to, individually or collectively, perform or support such operations.

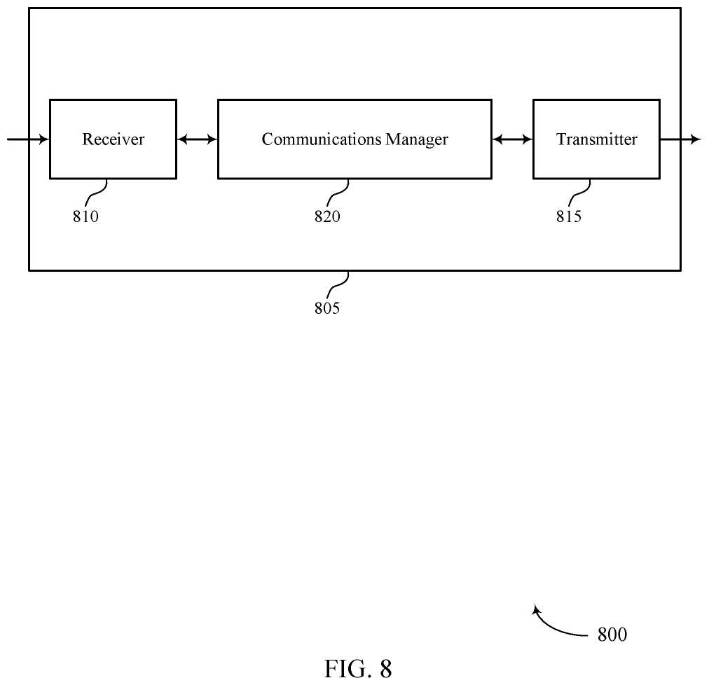

FIG. 8 shows a block diagram 800 of a device 805 that supports RACH procedure for uplink-dense deployment in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of RACH procedure for uplink-dense deployment as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting first signaling to a UE, where the first signaling includes an indication of configuration information associated with a second network entity having uplink-only transmission capabilities. The communications manager 820 is capable of, configured to, or operable to support a means for outputting second signaling for performing a random access procedure with the second network entity. The communications manager 820 is capable of, configured to, or operable to support a means for performing the random access procedure between the second network entity and the UE based on the configuration information in the first signaling and a threshold associated with the second signaling.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources, among other examples.

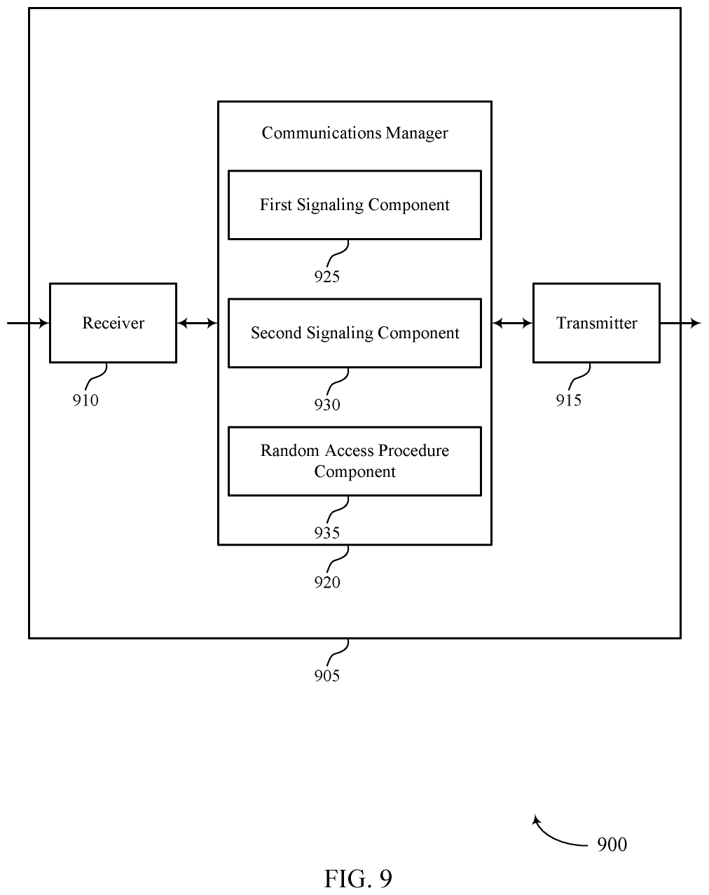

FIG. 9 shows a block diagram 900 of a device 905 that supports RACH procedure for uplink-dense deployment in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of RACH procedure for uplink-dense deployment as described herein. For example, the communications manager 920 may include a first signaling component 925, a second signaling component 930, a random access procedure component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The first signaling component 925 is capable of, configured to, or operable to support a means for outputting first signaling to a UE, where the first signaling includes an indication of configuration information associated with a second network entity having uplink-only transmission capabilities. The second signaling component 930 is capable of, configured to, or operable to support a means for outputting second signaling for performing a random access procedure with the second network entity. The random access procedure component 935 is capable of, configured to, or operable to support a means for performing the random access procedure between the second network entity and the UE based on the configuration information in the first signaling and a threshold associated with the second signaling.

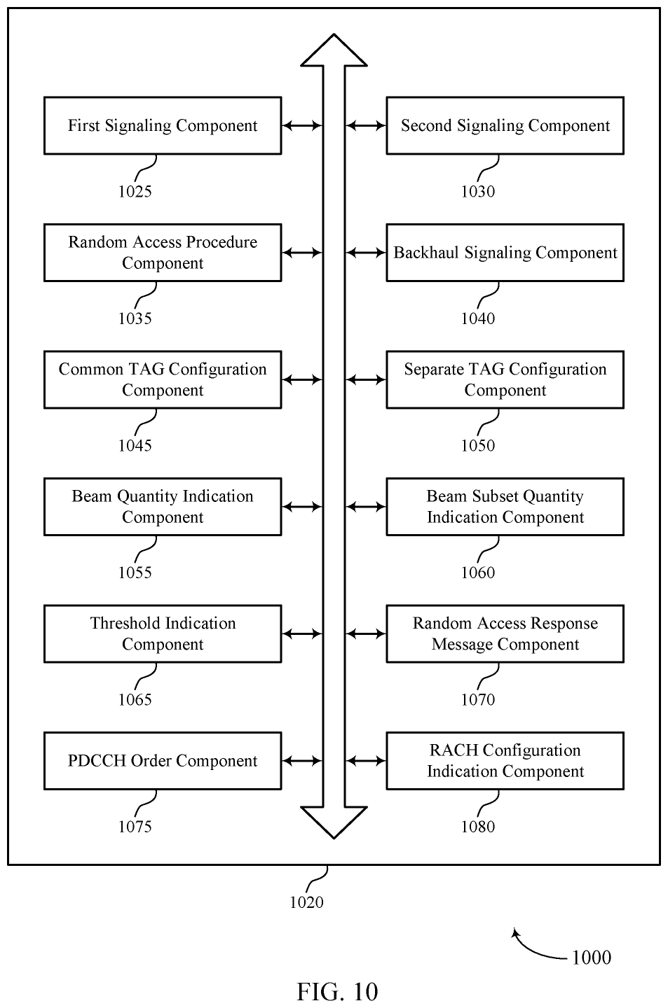

FIG. 10 shows a block diagram 1000 of a communications manager 1020 that supports RACH procedure for uplink-dense deployment in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of RACH procedure for uplink-dense deployment as described herein. For example, the communications manager 1020 may include a first signaling component 1025, a second signaling component 1030, a random access procedure component 1035, a backhaul signaling component 1040, a common TAG configuration component 1045, a separate TAG configuration component 1050, a beam quantity indication component 1055, a beam subset quantity indication component 1060, a threshold indication component 1065, a random access response message component 1070, a PDCCH order component 1075, a RACH configuration indication component 1080, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The first signaling component 1025 is capable of, configured to, or operable to support a means for outputting first signaling to a UE, where the first signaling includes an indication of configuration information associated with a second network entity having uplink-only transmission capabilities. The second signaling component 1030 is capable of, configured to, or operable to support a means for outputting second signaling for performing a random access procedure with the second network entity. The random access procedure component 1035 is capable of, configured to, or operable to support a means for performing the random access procedure between the second network entity and the UE based on the configuration information in the first signaling and a threshold associated with the second signaling.

In some examples, the backhaul signaling component 1040 is capable of, configured to, or operable to support a means for providing, via a backhaul connection with the second network entity, signaling associated with the random access procedure between the UE and the second network entity.

In some examples, to support outputting the first signaling, the common TAG configuration component 1045 is capable of, configured to, or operable to support a means for outputting an indication of a common timing advance group configuration that applies to both the first network entity and the second network entity, where performing the random access procedure with the UE is based on the indication of the common timing advance group configuration.

In some examples, to support outputting the first signaling, the separate TAG configuration component 1050 is capable of, configured to, or operable to support a means for outputting an indication of a separate timing advance group configuration for each of the first network entity and the second network entity, where performing the random access procedure with the UE is based on the indication of the separate timing advance group configuration.

In some examples, to support outputting the first signaling, the beam quantity indication component 1055 is capable of, configured to, or operable to support a means for outputting an indication of a first quantity of beams associated with the second network entity and a random access channel occasion, where performing the random access procedure is based on the indication of the first quantity of beams.

In some examples, the signaling for performing the random access procedure with the second network entity is the same or different than signaling for performing a random access procedure with a third network entity having uplink-only transmission capabilities.

In some examples, the beam subset quantity indication component 1060 is capable of, configured to, or operable to support a means for outputting an indication of a first quantity of beams as a subset of a second quantity of beams, the first quantity of beams associated with one or more random access messages, where the random access procedure is based on the indication.

In some examples, the threshold indication component 1065 is capable of, configured to, or operable to support a means for outputting an indication of the threshold, where the threshold is based on a signal strength associated with the first network entity. In some examples, the random access procedure component 1035 is capable of, configured to, or operable to support a means for performing the random access procedure between the second network entity and the UE based on the signal strength not exceeding the threshold.

In some examples, the random access response message component 1070 is capable of, configured to, or operable to support a means for outputting a random access response message based on performing the random access procedure, where the random access response message includes an identifier of either the first network entity or the second network entity based on a random access radio network temporary identifier associated with the random access response or a field indication in the random access response message.

In some examples, the random access response message further includes an indication of a timing advance value to be applied to a timing advance group associated with the second network entity based on a separate timing advance group configuration for each of the first network entity and the second network entity. In some examples, the random access response message further includes an indication of a reserved timing advance field or an indication of a timing advance value to be applied to a common timing advance group based on a common timing advance group configuration for both the first network entity and the second network entity.

In some examples, the PDCCH order component 1075 is capable of, configured to, or operable to support a means for outputting a physical downlink control channel order to the UE. In some examples, the RACH configuration indication component 1080 is capable of, configured to, or operable to support a means for outputting an indication of a random access channel configuration associated with the second network entity, and performing the random access procedure between the second network entity and the UE based on outputting the indication of the random access channel configuration.

In some examples, the random access response message component 1070 is capable of, configured to, or operable to support a means for outputting, to the UE, a random access response message including a first indication that one or more uplink messages associated with the random access procedure were undetected by the second network entity, where the random access response message further includes a second indication of a transmit power control. In some examples, the first indication is based on a bit in the random access response message or a value in a frequency domain resource assignment.

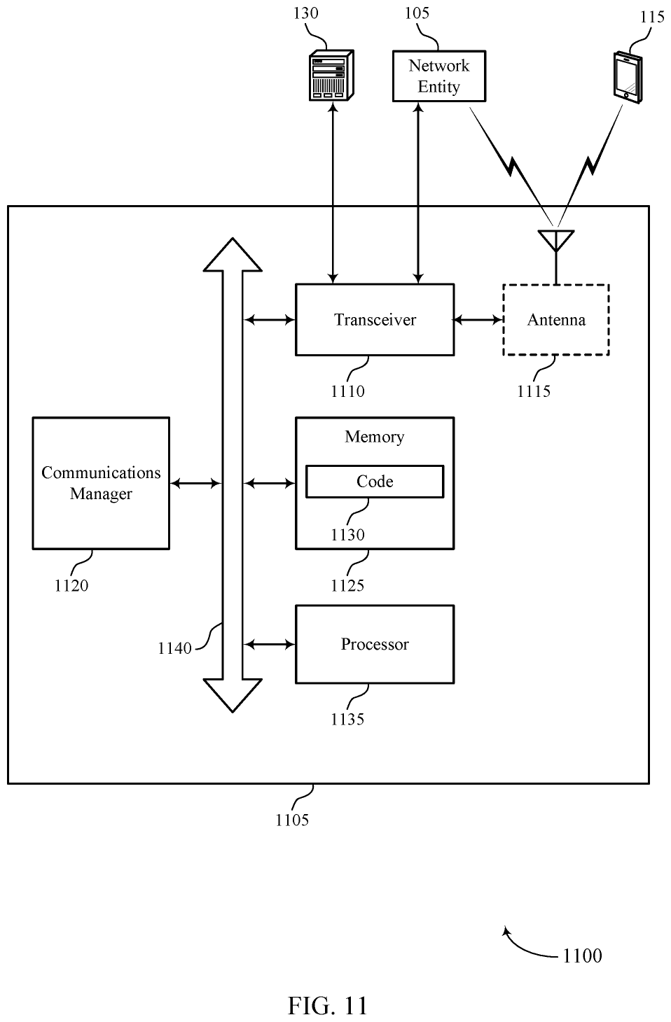

FIG. 11 shows a diagram of a system 1100 including a device 1105 that supports RACH procedure for uplink-dense deployment in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting RACH procedure for uplink-dense deployment). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network devices 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting first signaling to a UE, where the first signaling includes an indication of configuration information associated with a second network entity having uplink-only transmission capabilities. The communications manager 1120 is capable of, configured to, or operable to support a means for outputting second signaling for performing a random access procedure with the second network entity. The communications manager 1120 is capable of, configured to, or operable to support a means for performing the random access procedure between the second network entity and the UE based on the configuration information in the first signaling and a threshold associated with the second signaling.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability, among other examples.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of RACH procedure for uplink-dense deployment as described herein, or the at least one processor 1135 and the at least one memory 1125 may be otherwise configured to, individually or collectively, perform or support such operations.

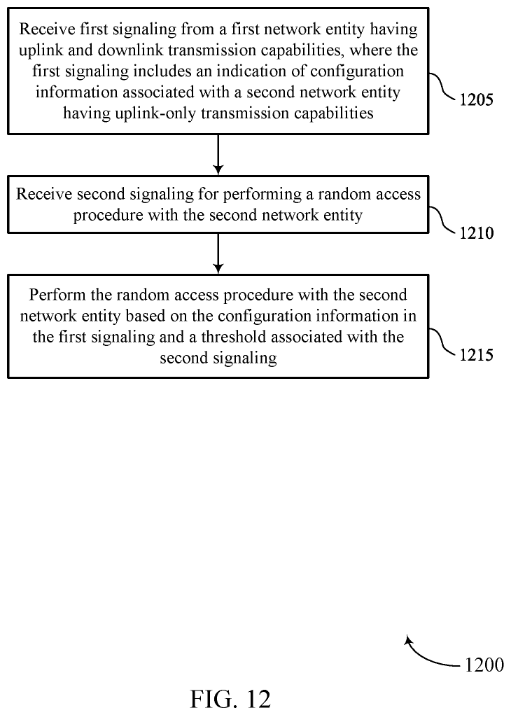

FIG. 12 shows a flowchart illustrating a method 1200 that supports RACH procedure for uplink-dense deployment in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving first signaling from a first network entity having uplink and downlink transmission capabilities, where the first signaling includes an indication of configuration information associated with a second network entity having uplink-only transmission capabilities. The operations of 1205 may be performed in accordance with examples as disclosed herein. In some examples, aspects of the operations of 1205 may be performed by a first signaling component 625 as described with reference to FIG. 6.

At 1210, the method may include receiving second signaling for performing a random access procedure with the second network entity. The operations of 1210 may be performed in accordance with examples as disclosed herein. In some examples, aspects of the operations of 1210 may be performed by a second signaling component 630 as described with reference to FIG. 6.

At 1215, the method may include performing the random access procedure with the second network entity based on the configuration information in the first signaling and a threshold associated with the second signaling. The operations of 1215 may be performed in accordance with examples as disclosed herein. In some examples, aspects of the operations of 1215 may be performed by a random access procedure component 635 as described with reference to FIG. 6.

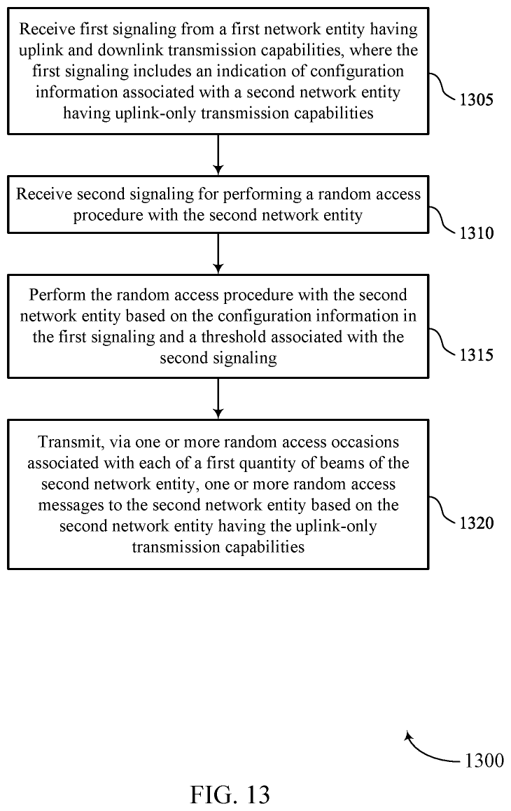

FIG. 13 shows a flowchart illustrating a method 1300 that supports RACH procedure for uplink-dense deployment in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving first signaling from a first network entity having uplink and downlink transmission capabilities, where the first signaling includes an indication of configuration information associated with a second network entity having uplink-only transmission capabilities. The operations of 1305 may be performed in accordance with examples as disclosed herein. In some examples, aspects of the operations of 1305 may be performed by a first signaling component 625 as described with reference to FIG. 6.

At 1310, the method may include receiving second signaling for performing a random access procedure with the second network entity. The operations of 1310 may be performed in accordance with examples as disclosed herein. In some examples, aspects of the operations of 1310 may be performed by a second signaling component 630 as described with reference to FIG. 6.

At 1315, the method may include performing the random access procedure with the second network entity based on the configuration information in the first signaling and a threshold associated with the second signaling. The operations of 1315 may be performed in accordance with examples as disclosed herein. In some examples, aspects of the operations of 1315 may be performed by a random access procedure component 635 as described with reference to FIG. 6.

At 1320, the method may include transmitting, via one or more random access occasions associated with each of a first quantity of beams of the second network entity, one or more random access messages to the second network entity based on the second network entity having the uplink-only transmission capabilities. The operations of 1320 may be performed in accordance with examples as disclosed herein. In some examples, aspects of the operations of 1320 may be performed by a random access message component 655 as described with reference to FIG. 6.

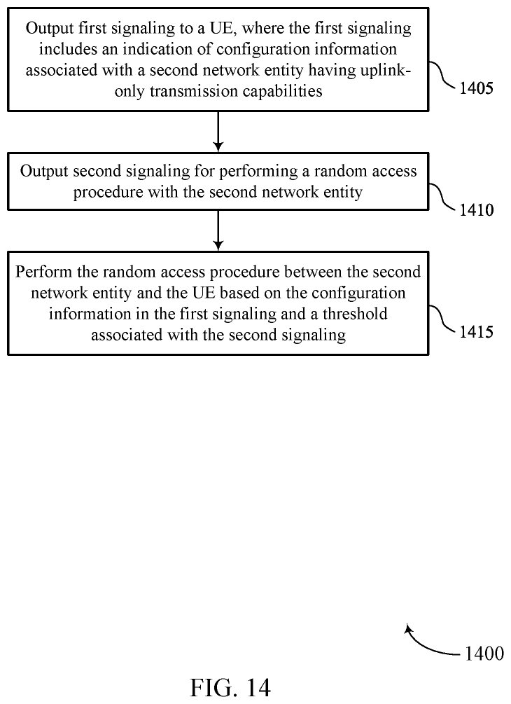

FIG. 14 shows a flowchart illustrating a method 1400 that supports RACH procedure for uplink-dense deployment in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting first signaling to a UE, where the first signaling includes an indication of configuration information associated with a second network entity having uplink-only transmission capabilities. The operations of 1405 may be performed in accordance with examples as disclosed herein. In some examples, aspects of the operations of 1405 may be performed by a first signaling component 1025 as described with reference to FIG. 10.

At 1410, the method may include outputting second signaling for performing a random access procedure with the second network entity. The operations of 1410 may be performed in accordance with examples as disclosed herein. In some examples, aspects of the operations of 1410 may be performed by a second signaling component 1030 as described with reference to FIG. 10.

At 1415, the method may include performing the random access procedure between the second network entity and the UE based on the configuration information in the first signaling and a threshold associated with the second signaling. The operations of 1415 may be performed in accordance with examples as disclosed herein. In some examples, aspects of the operations of 1415 may be performed by a random access procedure component 1035 as described with reference to FIG. 10.

The following provides an overview of aspects of the present disclosure:

Aspect 1: A method for wireless communications at a UE, comprising: receiving first signaling from a first network entity having uplink and downlink transmission capabilities, wherein the first signaling comprises an indication of configuration information associated with a second network entity having uplink-only transmission capabilities; receiving second signaling for performing a random access procedure with the second network entity; and performing the random access procedure with the second network entity based at least in part on the configuration information in the first signaling and a threshold associated with the second signaling.

Aspect 2: The method of aspect 1, wherein receiving the first signaling further comprises: receiving an indication of a common TAG configuration that applies to both the first network entity and the second network entity, wherein performing the random access procedure with either the first network entity or the second network entity is based at least in part on the indication of the common TAG configuration.

Aspect 3: The method of aspect 1, wherein receiving the first signaling further comprises: receiving an indication of a separate TAG configuration for each of the first network entity and the second network entity, wherein performing the random access procedure with the second network entity is based at least in part on the indication of the separate TAG configuration.

Aspect 4: The method of any of aspects 1 through 3, wherein receiving the first signaling further comprises: receiving an indication of a first quantity of beams associated with the second network entity and a RACH occasion, wherein performing the random access procedure with the second network entity is based at least in part on the indication of the first quantity of beams.

Aspect 5: The method of aspect 4, wherein the signaling for performing the random access procedure with the second network entity is the same or different than signaling for performing a random access procedure with a third network entity having uplink-only transmission capabilities.

Aspect 6: The method of any of aspects 1 through 5, wherein performing the random access procedure further comprises: transmitting, via one or more random access occasions associated with each of a first quantity of beams of the second network entity, one or more random access messages to the second network entity based at least in part on the second network entity having the uplink-only transmission capabilities.

Aspect 7: The method of aspect 6, further comprising: receiving an indication of the first quantity of beams as a subset of a second quantity of beams; and randomly selecting, from a set of random access occasions associated with the second quantity of beams, the one or more random access occasions for transmitting the one or more random access messages via the first quantity of beams.

Aspect 8: The method of any of aspects 1 through 7, wherein receiving the second signaling further comprises receiving an indication of the threshold, wherein the threshold is based at least in part on a signal strength associated with the first network entity; and performing the random access procedure with the second network entity based at least in part on the signal strength not exceeding the threshold.

Aspect 9: The method of any of aspects 1 through 8, further comprising: receiving a RAR message based at least in part on performing the random access procedure, wherein the RAR message comprises an identifier of either the first network entity or the second network entity based at least in part on a random access radio network temporary identifier associated with the RAR message or a field indication in the RAR message.

Aspect 10: The method of aspect 9, wherein the RAR message further comprises an indication of a timing advance value to be applied to a TAG associated with the second network entity based at least in part on a separate TAG configuration for each of the first network entity and the second network entity.

Aspect 11: The method of aspect 9, wherein the RAR message further comprises an indication of a reserved timing advance field or an indication of a timing advance value to be applied to a common TAG based at least in part on a common TAG configuration for both the first network entity and the second network entity.

Aspect 12: The method of any of aspects 1 through 11, further comprising: receiving a PDCCH order from the first network entity; and receiving an indication of a RACH configuration associated with the second network entity, wherein performing the random access procedure is based at least in part on receiving the indication of the RACH configuration.

Aspect 13: The method of any of aspects 1 through 12, further comprising: receiving, from the first network entity, a RAR message comprising a first indication that one or more uplink messages associated with the random access procedure were undetected by the second network entity, wherein the RAR message further comprises a second indication of a transmit power control; and retransmitting the one or more uplink messages associated with the random access procedure to the second network entity in accordance with an updated transmission power based at least in part on the second indication.

Aspect 14: The method of aspect 13, wherein the first indication is based at least in part on a bit in the RAR message or a value in a frequency domain resource assignment.

Aspect 15: A method for wireless communications at a first network entity having uplink and downlink transmission capabilities, comprising: outputting first signaling to a UE, wherein the first signaling comprises an indication of configuration information associated with a second network entity having uplink-only transmission capabilities; outputting second signaling for performing a random access procedure with the second network entity; and performing the random access procedure between the second network entity and the UE based at least in part on the configuration information in the first signaling and a threshold associated with the second signaling.

Aspect 16: The method of aspect 15, further comprising: providing, via a backhaul connection with the second network entity, signaling associated with the random access procedure between the UE and the second network entity.

Aspect 17: The method of any of aspects 15 through 16, wherein outputting the first signaling further comprises: outputting an indication of a common TAG configuration that applies to both the first network entity and the second network entity, wherein performing the random access procedure with the UE is based at least in part on the indication of the common TAG configuration.

Aspect 18: The method of any of aspects 15 through 16, wherein outputting the first signaling further comprises: outputting an indication of a separate TAG configuration for each of the first network entity and the second network entity, wherein performing the random access procedure with the UE is based at least in part on the indication of the separate TAG configuration.

Aspect 19: The method of any of aspects 15 through 18, wherein outputting the first signaling further comprises: outputting an indication of a first quantity of beams associated with the second network entity and a RACH occasion, wherein performing the random access procedure is based at least in part on the indication of the first quantity of beams.

Aspect 20: The method of aspect 19, wherein the signaling for performing the random access procedure with the second network entity is the same or different than signaling for performing a random access procedure with a third network entity having uplink-only transmission capabilities.

Aspect 21: The method of any of aspects 15 through 20, further comprising: outputting an indication of a first quantity of beams as a subset of a second quantity of beams, the first quantity of beams associated with one or more random access messages, wherein the random access procedure is based at least in part on the indication.

Aspect 22: The method of any of aspects 15 through 21, further comprising: outputting an indication of the threshold, wherein the threshold is based at least in part on a signal strength associated with the first network entity; and performing the random access procedure between the second network entity and the UE based at least in part on the signal strength not exceeding the threshold.

Aspect 23: The method of any of aspects 15 through 22, further comprising: outputting a RAR message based at least in part on performing the random access procedure, wherein the RAR message comprises an identifier of either the first network entity or the second network entity based at least in part on a random access radio network temporary identifier associated with the RAR or a field indication in the RAR message.

Aspect 24: The method of aspect 23, wherein the RAR message further comprises an indication of a timing advance value to be applied to a TAG associated with the second network entity based at least in part on a separate TAG configuration for each of the first network entity and the second network entity.

Aspect 25: The method of aspect 23, wherein the RAR message further comprises an indication of a reserved timing advance field or an indication of a timing advance value to be applied to a common TAG based at least in part on a common TAG configuration for both the first network entity and the second network entity.

Aspect 26: The method of any of aspects 15 through 25, further comprising: outputting a PDCCH order to the UE; and outputting an indication of a RACH configuration associated with the second network entity, wherein performing the random access procedure between the second network entity and the UE is based at least in part on outputting the indication of the RACH configuration.

Aspect 27: The method of any of aspects 15 through 26, further comprising: outputting, to the UE, a RAR message comprising a first indication that one or more uplink messages associated with the random access procedure were undetected by the second network entity, wherein the RAR message further comprises a second indication of a transmit power control.

Aspect 28: The method of aspect 27, wherein the first indication is based at least in part on a bit in the RAR message or a value in a frequency domain resource assignment.

Aspect 29: A UE for wireless communications, comprising one or more memories storing processor-executable code, and one or more processors coupled with the one or more memories and individually or collectively operable to execute the code to cause the UE to perform a method of any of aspects 1 through 14.

Aspect 30: A UE for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A first network entity having uplink and downlink transmission capabilities for wireless communications, comprising one or more memories storing processor-executable code, and one or more processors coupled with the one or more memories and individually or collectively operable to execute the code to cause the first network entity having uplink and downlink transmission capabilities to perform a method of any of aspects 15 through 28.

Aspect 33: A first network entity having uplink and downlink transmission capabilities for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first signaling from a first network entity having uplink and downlink transmission capabilities, wherein the first signaling comprises an indication of configuration information associated with a second network entity having uplink-only transmission capabilities;
receive second signaling for performing a random access procedure with the second network entity; and
perform the random access procedure with the second network entity based at least in part on the configuration information in the first signaling and a threshold associated with the second signaling.

2. The UE of claim 1, wherein, to receive the first signaling, the one or more processors are individually or collectively further operable to execute the code to cause the UE to:
receive an indication of a common timing advance group configuration that applies to both the first network entity and the second network entity, wherein performing the random access procedure with either the first network entity or the second network entity is based at least in part on the indication of the common timing advance group configuration.

3. The UE of claim 1, wherein, to receive the first signaling, the one or more processors are individually or collectively further operable to execute the code to cause the UE to:
receive an indication of a separate timing advance group configuration for each of the first network entity and the second network entity, wherein performing the random access procedure with the second network entity is based at least in part on the indication of the separate timing advance group configuration.

4. The UE of claim 1, wherein, to receive the first signaling, the one or more processors are individually or collectively further operable to execute the code to cause the UE to:
receive an indication of a first quantity of beams associated with the second network entity and a random access channel occasion, wherein performing the random access procedure with the second network entity is based at least in part on the indication of the first quantity of beams.

5. The UE of claim 4, wherein the signaling for performing the random access procedure with the second network entity is the same or different than signaling for performing a random access procedure with a third network entity having uplink-only transmission capabilities.

6. The UE of claim 1, wherein, to perform the random access procedure, the one or more processors are individually or collectively further operable to execute the code to cause the UE to:
transmit, via one or more random access occasions associated with each of a first quantity of beams of the second network entity, one or more random access messages to the second network entity based at least in part on the second network entity having the uplink-only transmission capabilities.

7. The UE of claim 6, wherein the one or more processors are individually or collectively further operable to execute the code to cause the UE to:
receive an indication of the first quantity of beams as a subset of a second quantity of beams; and
randomly select, from a set of random access occasions associated with the second quantity of beams, the one or more random access occasions for transmitting the one or more random access messages via the first quantity of beams.

8. The UE of claim 1, wherein, to receive the second signaling, the one or more processors are individually or collectively further operable to execute the code to cause the UE to:
receive an indication of the threshold, wherein the threshold is based at least in part on a signal strength associated with the first network entity; and
perform the random access procedure with the second network entity based at least in part on the signal strength not exceeding the threshold.

9. The UE of claim 1, wherein the one or more processors are individually or collectively further operable to execute the code to cause the UE to:
receive a random access response message based at least in part on performing the random access procedure, wherein the random access response message comprises an identifier of either the first network entity or the second network entity based at least in part on a random access radio network temporary identifier associated with the random access response message or a field indication in the random access response message.

10. The UE of claim 9, wherein the random access response message further comprises an indication of a timing advance value to be applied to a timing advance group associated with the second network entity based at least in part on a separate timing advance group configuration for each of the first network entity and the second network entity.

11. The UE of claim 9, wherein the random access response message further comprises an indication of a reserved timing advance field or an indication of a timing advance value to be applied to a common timing advance group based at least in part on a common timing advance group configuration for both the first network entity and the second network entity.

12. The UE of claim 1, wherein the one or more processors are individually or collectively further operable to execute the code to cause the UE to:
receive a physical downlink control channel order from the first network entity; and
receive an indication of a random access channel configuration associated with the second network entity, wherein performing the random access procedure is based at least in part on receiving the indication of the random access channel configuration.

13. The UE of claim 1, wherein the one or more processors are individually or collectively further operable to execute the code to cause the UE to:
receive, from the first network entity, a random access response message comprising a first indication that one or more uplink messages associated with the random access procedure were undetected by the second network entity, wherein the random access response message further comprises a second indication of a transmit power control; and
retransmit the one or more uplink messages associated with the random access procedure to the second network entity in accordance with an updated transmission power based at least in part on the second indication.

14. The UE of claim 13, wherein the first indication is based at least in part on a bit in the random access response message or a value in a frequency domain resource assignment.

15. A first network entity having uplink and downlink transmission capabilities, comprising:
one or more memories storing processor-executable code; and
one or more processors coupled with the one or more memories and individually or collectively operable to execute the code to cause the first network entity having uplink and downlink transmission capabilities to:
output first signaling to a user equipment (UE), wherein the first signaling comprises an indication of configuration information associated with a second network entity having uplink-only transmission capabilities;
output second signaling for performing a random access procedure with the second network entity; and
perform the random access procedure between the second network entity and the UE based at least in part on the configuration information in the first signaling and a threshold associated with the second signaling.

16. The first network entity of claim 15, wherein the one or more processors are individually or collectively further operable to execute the code to cause the first network entity having uplink and downlink transmission capabilities to:
provide, via a backhaul connection with the second network entity,
signaling associated with the random access procedure between the UE and the second network entity.

17. The first network entity of claim 15, wherein, to output the first signaling, the one or more processors are individually or collectively further operable to execute the code to cause the first network entity having uplink and downlink transmission capabilities to:
output an indication of a common timing advance group configuration that applies to both the first network entity and the second network entity, wherein performing the random access procedure with the UE is based at least in part on the indication of the common timing advance group configuration.

18. The first network entity of claim 15, wherein, to output the first signaling, the one or more processors are individually or collectively further operable to execute the code to cause the first network entity having uplink and downlink transmission capabilities to:
output an indication of a separate timing advance group configuration for each of the first network entity and the second network entity, wherein performing the random access procedure with the UE is based at least in part on the indication of the separate timing advance group configuration.

19. The first network entity of claim 15, wherein, to output the first signaling, the one or more processors are individually or collectively further operable to execute the code to cause the first network entity having uplink and downlink transmission capabilities to:
output an indication of a first quantity of beams associated with the second network entity and a random access channel occasion, wherein performing the random access procedure is based at least in part on the indication of the first quantity of beams.

20. The first network entity of claim 19, wherein the signaling for performing the random access procedure with the second network entity is the same or different than signaling for performing a random access procedure with a third network entity having uplink-only transmission capabilities.

21. The first network entity of claim 15, wherein the one or more processors are individually or collectively further operable to execute the code to cause the first network entity having uplink and downlink transmission capabilities to:
output an indication of a first quantity of beams as a subset of a second quantity of beams, the first quantity of beams associated with one or more random access messages, wherein the random access procedure is based at least in part on the indication.

22. The first network entity of claim 15, wherein the one or more processors are individually or collectively further operable to execute the code to cause the first network entity having uplink and downlink transmission capabilities to:
output an indication of the threshold, wherein the threshold is based at least in part on a signal strength associated with the first network entity; and
perform the random access procedure between the second network entity and the UE based at least in part on the signal strength not exceeding the threshold.

23. The first network entity of claim 15, wherein the one or more processors are individually or collectively further operable to execute the code to cause the first network entity having uplink and downlink transmission capabilities to:
output a random access response message based at least in part on performing the random access procedure, wherein the random access response message comprises an identifier of either the first network entity or the second network entity based at least in part on a random access radio network temporary identifier associated with the random access response or a field indication in the random access response message.

24. The first network entity of claim 23, wherein the random access response message further comprises an indication of a timing advance value to be applied to a timing advance group associated with the second network entity based at least in part on a separate timing advance group configuration for each of the first network entity and the second network entity.

25. The first network entity of claim 23, wherein the random access response message further comprises an indication of a reserved timing advance field or an indication of a timing advance value to be applied to a common timing advance group based at least in part on a common timing advance group configuration for both the first network entity and the second network entity.

26. The first network entity of claim 15, wherein the one or more processors are individually or collectively further operable to execute the code to cause the first network entity having uplink and downlink transmission capabilities to:
output a physical downlink control channel order to the UE; and
output an indication of a random access channel configuration associated with the second network entity, wherein performing the random access procedure between the second network entity and the UE is based at least in part on outputting the indication of the random access channel configuration.

27. The first network entity of claim 15, wherein the one or more processors are individually or collectively further operable to execute the code to cause the first network entity having uplink and downlink transmission capabilities to:
output, to the UE, a random access response message comprising a first indication that one or more uplink messages associated with the random access procedure were undetected by the second network entity, wherein the random access response message further comprises a second indication of a transmit power control.

28. The first network entity of claim 27, wherein the first indication is based at least in part on a bit in the random access response message or a value in a frequency domain resource assignment.

29. A method for wireless communications at a user equipment (UE), comprising:
receiving first signaling from a first network entity having uplink and downlink transmission capabilities, wherein the first signaling comprises an indication of configuration information associated with a second network entity having uplink-only transmission capabilities;
receiving second signaling for performing a random access procedure with the second network entity; and
performing the random access procedure with the second network entity based at least in part on the configuration information in the first signaling and a threshold associated with the second signaling.

30. A method for wireless communications at a first network entity having uplink and downlink transmission capabilities, comprising:
outputting first signaling to a user equipment (UE), wherein the first signaling comprises an indication of configuration information associated with a second network entity having uplink-only transmission capabilities;
outputting second signaling for performing a random access procedure with the second network entity; and
performing the random access procedure between the second network entity and the UE based at least in part on the configuration information in the first signaling and a threshold associated with the second signaling.
